(19) United States
(12) Patent Application Publication
(10) Pub. No.: US 2010/0039014 A1
(43) Pub. Date: Feb. 18, 2010

(54) ELECTRON MULTIPLIERS

(75) Inventors: Yong Hyup Kim, Seoul (KR); Seung Min Lee, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SEOUL NATIONAL UNIVERSITY RESEARCH & DEVELOPMENT BUSINESS FOUNDATION (SNU R&DB FOUNDATION), Seoul (KR)

(21) Appl. No.: 12/192,019

(22) Filed: Aug. 14, 2008

(51) Int. Cl. H01J 43/00; H01J 9/12

(52) U.S. Cl. 313/103 R; 445/51

(57) ABSTRACT

Electron multipliers and techniques for manufacturing electron multipliers are provided. In one embodiment, an electron multiplier includes at least two electrodes, a plurality of electron emission tips for emitting electrons formed on one of the at least two electrodes, and at least one porous structure having a plurality of pores for multiplying the electrons emitted from the plurality of electron emission tips. The porous structure includes a metal core and a layer of insulator material coated on an outer surface of the metal core, and is disposed between the at least two electrodes.

### TECHNICAL FIELD

The present disclosure relates generally to electron multipliers and, more particularly, to electron multipliers having a high secondary electron yield.

### BACKGROUND

In flat panel display devices, such as field emission display devices and liquid crystal display devices, the electron beams emitted from the electron emission tips tend to scatter, resulting in a reduced intensity and uniformity of the light emitted from the emission tips. Electron multipliers are widely used in such flat panel display devices in order to improve image brightness and uniformity.

Typically, electron multipliers are comprised of channels having an interior wall of glass or ceramics, where an electron accelerated by an electric field collides against the surface of the wall of the channel to generate a plurality of secondary electrons. One of the commonly known electron multipliers include microchannel plates, which are glass plates perforated with a regular, parallel array of microscopic channels, e.g., cylindrical and hollow channels.

### SUMMARY

Various embodiments of electron multipliers and methods for manufacturing electron multipliers are provided. In one embodiment, an electron multiplier includes at least two electrodes, a plurality of electron emission tips for emitting electrons formed on one of the at least two electrodes, and at least one porous structure having a plurality of pores for multiplying the electrons emitted from the plurality of electron emission tips. The porous structure includes a metal core and a layer of insulator material coated on an outer surface of the metal core, the porous structure being disposed between the at least two electrodes. Various devices including the above electron multiplier are also disclosed herein.

In another embodiment, a method of manufacturing an electron multiplier involves providing at least one porous structure having a plurality of pores, where the porous structure includes a metal core and a layer of insulator material coated on an outer surface of the metal core, and assembling the porous structure between at least two electrodes, where one of the at least two electrodes has a plurality of electron emission tips formed on the electrode.

This Summary is provided to introduce a selection of concepts in a simplified form that are further described below in the Detailed Description. This Summary is not intended to identify key features or essential features of the claimed subject matter, nor is it intended to be used limit the scope of the claimed subject matter.

### BRIEF DESCRIPTION OF THE DRAWINGS

FIGS. 1(A)-(B) are schematic diagrams showing a top plane view of an illustrative embodiment of a porous structure used in an electron multiplier and a cross-sectional view of a portion of the same porous structure, respectively.

FIG. 2 is a flow chart of an illustrative embodiment of a method for manufacturing an electron multiplier.

FIG. 3 is a schematic diagram showing a side view of an illustrative embodiment of an electron multiplier including the porous structure.

FIG. 4 is a schematic diagram showing a side view of an illustrative embodiment of an electron multiplier including more than one porous structure.

FIG. 5 is a schematic diagram showing a side sectional view of an illustrative embodiment of a field emission display (FED) device including the above-described porous structure.

FIG. 6 is a schematic diagram showing a side sectional view of an illustrative embodiment of a flat light source for a liquid crystal display device (LCD) including the above-described porous structure.

FIG. 7 is a schematic diagram showing a side sectional view of an illustrative embodiment of a flat light source for a LCD device including two porous structures.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and made part of this disclosure.

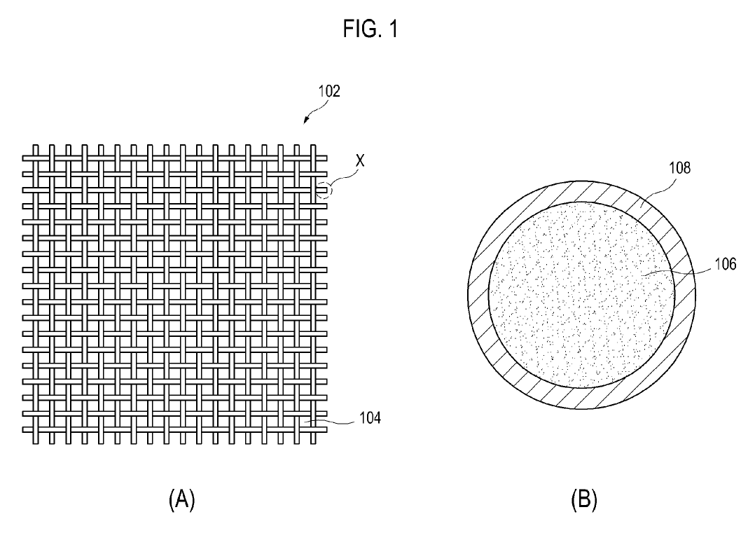

In various illustrative embodiments, the present disclosure provides for electron multipliers including at least one porous structure for multiplying electrons. Referring to FIGS. 1(A)-(B), an illustrative embodiment of a porous structure 102 used in an electron multiplier is shown. The porous structure 102 has a plurality of pores 104 and may include a metal core 106 and a layer of insulator material 108 coated on an outer surface of the metal core 106, as illustrated in FIGS. 1(A)-(B). In some embodiments, the porous structure 102 may be a mesh or lattice structure made from insulated metal wires. FIG. 1(A) shows a top plane view of the porous structure 102, while FIG. 1(B) shows a cross-sectional view of a portion (i.e., the encircled portion labeled as “X”) of the porous structure 102 shown in FIG. 1(A). In certain embodiments, the porous structure 102 has a planar shape, making it easy for the porous structure to generate uniform secondary electrons. In some embodiments, the size of the pores 104 in the porous structure 102 may range from about 50 μm to about 2 mm.

Any metal capable of functioning as an electrode may be used for the metal core 106 of the porous structure 102 including, but not limited to, Fe, Cs, W, Mo, Ta, and Cu. Further, any material capable of generating secondary electrons may be used for the insulator material 108 in the porous structure 102 including, but not limited to, Al₂O₃, ZnO, CaO, SrO, SiO₂, MgO, La₂O₃, MgF₂, CaF₂, and LiF.

In some embodiments, the layer of insulator material 108 may have a thickness ranging from about 500 Å to about 5000 Å. For example, the porous structure may include an Al₂O₃ insulator layer having a thickness of about 3000 Å. Although a thicker layer of insulator material generates more secondary electrons, if the layer of insulator material is too thick, the metal core of the porous structure may not be subjected to the voltage that is applied to the electron multiplier.

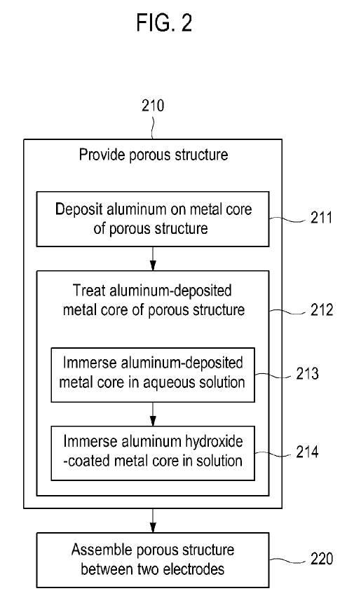

FIG. 2 is a flow chart of an illustrative embodiment of a method for manufacturing an electron multiplier. Initially, at operation 210, at least one porous structure having a plurality of pores is provided. The porous structure may include a metal core and a layer of insulator material coated on the outer surface of the metal core. Then, at operation 220, the porous structure is assembled between the at least two electrodes, where one of the at least two electrodes has a plurality of electron emission tips formed on the electrode.

In selected embodiments where the insulator material is aluminum oxide, the porous structure may be prepared by first depositing aluminum on a metal core of a structure having a plurality of pores, e.g., a metal mesh, as shown at operation 211. Operation 211 may be carried out by thermal evaporation, sputtering, e-beam evaporation, and the like. Next, at operation 212, the aluminum-deposited metal core is treated under conditions effective to oxidize the aluminum and coat the metal core with a layer of aluminum oxide. In some embodiments, operation 212 may include immersing the aluminum-deposited metal core in an aqueous solution under conditions effective to convert the aluminum on the metal core to aluminum hydroxide, as shown at operation 213, and immersing the aluminum hydroxide-coated metal core in a solution under conditions effective to convert the aluminum hydroxide to aluminum oxide, as shown at operation 214.

Operation 213 may be carried out by immersing the aluminum-deposited metal core in an aqueous solution, such as deionized water, at a temperature ranging from about 70° C. to about 100° C. for about 5 minutes. Further, operation 214 may be carried out by immersing the aluminum hydroxide-coated metal core in a solution (e.g., 2.3 M boric acid solution) where a voltage (e.g., 200V to 500V) is applied for about 5 to 20 minutes. As a result, a porous structure including a metal core and an aluminum oxide layer coated on the outer surface of the metal core is produced. Such a porous structure has a high secondary electron yield, i.e., about 2.3 secondary electron yield.

In other embodiments where the insulator material is an oxide other than aluminum oxide or a fluoride, providing the porous structure (i.e., operation 210) may be carried out by directly depositing the oxide or fluoride insulator material itself on the metal core, without performing operations 211 to 214 described above.

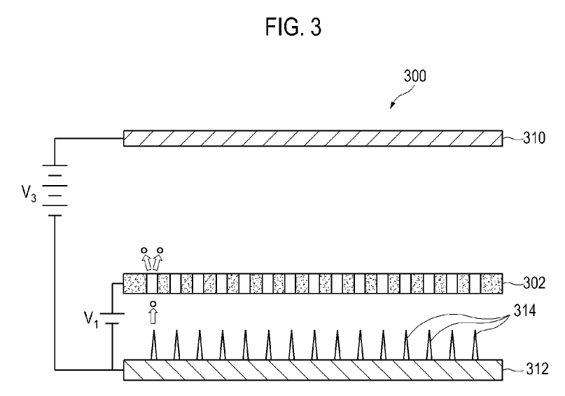

FIG. 3 is a schematic diagram showing a side view of an illustrative embodiment of an electron multiplier 300 including a porous structure 302. As illustrated in FIG. 3, the electron multiplier 300 may include at least two electrodes 310, 312, a plurality of electron emission tips 314 for emitting electrons formed on one of the at least two electrodes 310, 312, and at least one porous structure 302 for multiplying the electrons emitted from the plurality of electron emission tips 314, where the porous structure 302 is disposed between the at least two electrodes 310, 312. In the depicted electron multiplier 300, the plurality of electron emission tips 314 is formed on the electrode 312.

In operation, a voltage V, may be applied between the porous structure 302 and the electrode 312, e.g., the cathode, inducing an electrostatic field that generates primary electrons from the electron emission tips 314, which are conductively connected to the electrode 312. The voltage V₁ is typically higher than the turn-on voltage of the electron emission tips 314, so that the primary electrons are released and expelled from the electron emission tips 314. The expelled primary electrons strike the porous structure 302, generating a plurality of secondary electrons. The plurality of secondary electrons generated from the porous structure 302 then collides with the other electrode 310, e.g., the anode, where a voltage V₃ is applied between the two electrodes 310, 312. In some embodiments, the secondary electrons may hit (e.g., contact) a phosphorous layer (not shown) on the surface of the electrode 310 causing a light to emit and a picture to display on a screen (not shown). An electron multiplier that includes the above-described porous structure emits a very bright light at the phosphorous layer, because the plurality of secondary electrons multiplied by the porous structure are uniformly emitted toward the electrode.

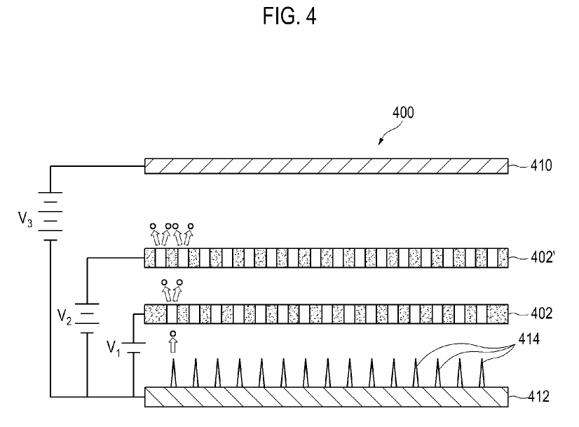

In some embodiments, an electron multiplier may employ more than one of the above-described porous structures. FIG. 4 is a schematic diagram showing a side view of an illustrative embodiment of an electron multiplier 400 including two porous structures 402, 402′. As illustrated in FIG. 4, the electron multiplier 400 may include at least two electrodes 410, 412, a plurality of electron emission tips 414 for emitting electrons formed on the electrode 412, and two porous structures 402, 402′ for multiplying the electrons emitted from the plurality of electron emission tips 414, where the porous structures 402, 402′ are disposed between the at least two electrodes 410, 412. In the depicted electron multiplier 400, the plurality of electron emission tips 414 are formed on the electrode 412.

In operation, a voltage V₂ may be applied between the second porous structure 402′ and the electrode 412. The voltage V₂ is typically higher than the voltage V₁, which is applied between the first porous structure 402 and the electrode 412, and proportional to the distance between the two porous structures 402, 402′. In some embodiments, the voltage V₂ may be at least 0.1 V/μm. The electron multiplier 400 having two porous structures 402, 402′ emits a brighter light at the phosphorous layer, as compared with an electron multiplier that includes only one porous structure (e.g., the electron multiplier 300), since the electrons, which are multiplied by the first porous structure 402, are multiplied again at the second porous structure 402′, resulting in an increased number of electrons.

Recently, carbon nanotubes (CNTs) have attracted attention as suitable material for electron emission tips since the turn-on voltage of electron emission tips made with CNTs is very low, i.e., in the order of 10, and the generated current is high, i.e., in the order of 10 to 100, as compared with conventional electron emission tips. However, a drawback to FED devices having electron emission tips made with CNTs is that the images may not be uniformly displayed, the reason being that the CNTs, which have high elasticity and low mass, shake when an electrical field is applied to the electron emission tips. The above-described porous structures can improve the image uniformity of the CNT field emitters without the loss of brightness because they can generate a number of secondary electrons and disperse the trajectory of the electrons. The porous structures provided by the illustrative embodiments described above are not only useable in FED devices having CNT electron emission tips but are also applicable to FED devices having metal tip-type field emitters.

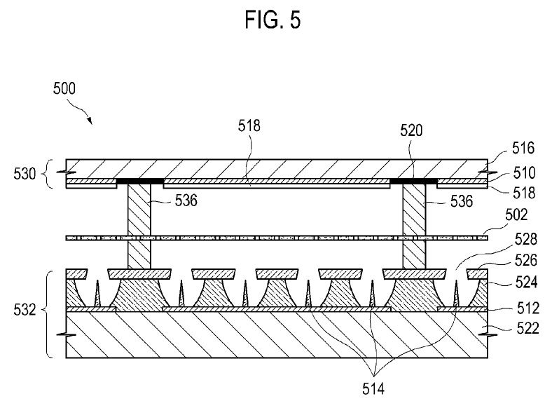

FIG. 5 is a schematic diagram showing a side sectional view of an illustrative embodiment of a FED device 500 including a porous structure 502. As illustrated in FIG. 5, the FED device 500 may include two substrates, e.g., a front substrate 530 and a rear substrate 532, which oppose each other with a gap therebetween maintained by spacers 536 and the porous structure 502 between the two substrates 530, 532. The gap between the front substrate 530 and the rear substrate 532 may range from about 200 μm to about 2 mm and is maintained at a vacuum (e.g., above 10⁻⁶ Torr). The front substrate 530 and the rear substrate 532 may be made by conventional semiconductor manufacturing technologies, such as deposition, photolithography, and etching.

In some embodiments, the rear substrate 532 may include a first substrate 522, at least one cathode 512, a plurality of electron emission tips 514, and an insulator layer 524. The first substrate 522 may be made of glass and other like material, while the cathodes 512 may be made of metals, such as Cr, Ti, W, etc. The cathodes 512 may be formed on the first substrate 522 in a stripe pattern. In addition, the plurality of electron emission tips 514 for emitting electrons are typically formed as conical shapes on the cathodes 512. The electron emission tips 514 may be made of metals having a low work function, such as Mo and Ta, and Si, or nanostructures, such as CNTs. Semiconductor patterning technology may be used to make hundreds of electron emission tips corresponding to one pixel. It is beneficial for the electron emission tip 514 to be as sharp as possible. The electron emission tips 514 may be formed on the cathodes 512 and exposed through holes 528 formed in the insulator layer 524. The insulator layer 524 may be formed between the electron emission tips 514. Optionally, primary electron gates 526 may be included in the FED device to facilitate the emission of primary electrons under a low applied voltage. The primary electron gates 526 may be formed on the insulator layer 524 in a stripe pattern, which traverses the stripe pattern of the cathodes 512. The primary electron gates 526 are separated from the pointed ends of the electron emission tips 514. The primary electron gates 526 may be made of metals, such as Mo, Cr, and Ti. To the extent conventional photolithography methods allow, it is beneficial to fabricate the FED device 500 such that the distance between the electron emission tips 514 and the primary electron gates 526 is short, which allows the primary electrons to be released from the electron emission tips 514 more easily.

In some embodiments, the front substrate 530 may include a second substrate 516, at least one anode 510, phosphorous layers 518, and black matrices 520. The anode 510 is formed on the second substrate 516 in a striped pattern, which is parallel to the striped pattern of the cathode 512. The second substrate 516 may be made of glass and other like material, while the anode may be made of materials, such as indium tin oxide (ITO). Further, the phosphorous layers 518 displaying red, green, and blue may be formed on the anodes 510. The black matrices 520 are positioned between the formed phosphorous layers 518 to prevent the interference between the colors. The spacers 536 are arranged on the black matrices 520 to maintain the gap between the two substrates 530, 532. The spacers 536 can be formed using paste by a screen printing method. As illustrated in FIG. 5, the porous structure 502 between the front substrate 530 and the rear substrate 532 may be secured with the spacers 536.

In the FED devices of the illustrative embodiments described above, the primary electrons hit the porous structure, which in turn generates a large number of secondary electrons that hit the phosphorous layers of the device, resulting in increased brightness. Due to the increased brightness of the FED device including the porous structure described herein, such FED devices only require a low driving voltage, resulting in reduced costs and improved electron yield.

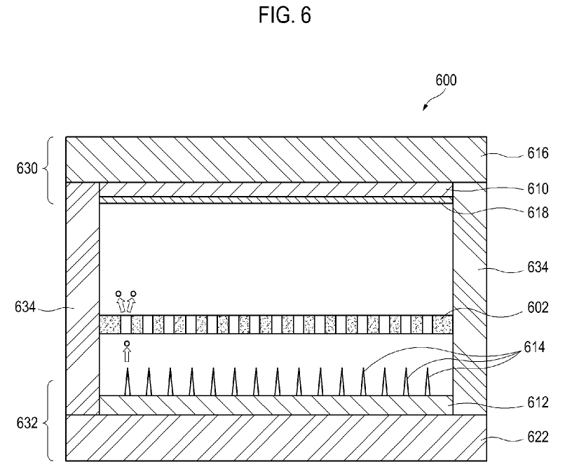

FIG. 6 is a schematic diagram showing a side sectional view of an illustrative embodiment of a flat light source (or backlight) 600 for a LCD device including the above-described porous structure. In some embodiments, the flat light source 600, as illustrated in FIG. 6, may include a front substrate 630, a rear substrate 632, and a porous structure 602 positioned between the two substrates 630, 632. The front substrate 630, the rear substrate 632, and the porous structure 602 can be secured by side walls 634. Although not shown in FIG. 6, spacers may also be used to secure the porous structure 602 within the flat light source 600.

In some embodiments, the rear substrate 632 may include a first substrate 622, a cathode 612, and a plurality of electron emission tips 614 formed on the cathode 612. Unlike the cathodes used in display devices such as FED devices, the cathode 612 in the flat light source 600 may be a single planar electrode and may or may not be a striped pattern since there is no need to produce pixels in the case of a backlight.

In some embodiments, the front substrate 630 may include a second substrate 616, an anode 610, and a phosphorous layer 618. The second substrate 616 and the anode 610 may be made of transparent materials such as glass and ITO, respectively. Further, the anode 610 in the flat light source 600 may be a single planar electrode and may or may not be a striped pattern.

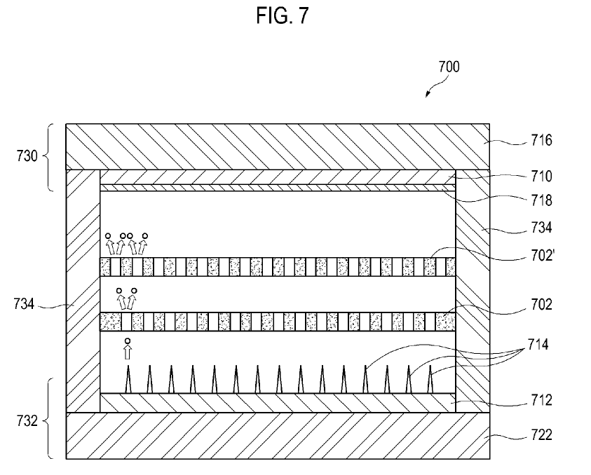

In some embodiments, a flat light source may employ more than one of the above-described porous structures. FIG. 7 is a schematic diagram showing a side sectional view of an illustrative embodiment of a flat light source 700 for a LCD device including two porous structures 702, 702′. In some embodiments, the flat light source 700, as illustrated in FIG. 7, may include a front substrate 730, a rear substrate 732, and two porous structures 702, 702′ between the two substrates 730, 732. In some embodiments, the rear substrate 732 may include a first substrate 722, a cathode 712, and a plurality of electron emission tips 714. In some embodiments, the front substrate 730 may include a second substrate 716, an anode 710, and a phosphorous layer 718. The front substrate 730, the rear substrate 732, and the porous structures 702, 702′ may be secured by side walls 734.

In the flat light sources of the illustrative embodiments described above, the generated primary electrons hit the porous structure, which in turn generates a large number of secondary electrons that hit the phosphorous layer, resulting in an improved performance of the LCD device. Due to the increased brightness and uniform images, such LCD devices only require a low driving voltage.

The present disclosure also provides for photomultipliers or photodetectors including the electron multipliers of the illustrative embodiments described above. In some embodiments, a photodetector may include an electron collector attached to an anode, instead of the phosphorous layer included in the FED or LCD devices described above. In operation, the porous structures of the illustrative embodiments described above multiply the electrons received by the photodetector and, thus, increase the sensitivity at the anode in the photodetector.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An electron multiplier comprising:
at least two electrodes;
a plurality of electron emission tips for emitting electrons formed on one of the at least two electrodes; and
at least one porous structure having a plurality of pores for multiplying the electrons emitted from the plurality of electron emission tips, wherein the porous structure includes a metal core and a layer of insulator material coated on an outer surface of the metal core, the porous structure being disposed between the at least two electrodes.

2. The electron multiplier of claim 1, wherein the porous structure has a planar shape.

3. The electron multiplier of claim 1, wherein the porous structure is a mesh.

4. The electron multiplier of claim 1, wherein the size of the pores in the porous structure ranges from about 50 μm to about 2 mm.

5. The electron multiplier of claim 1, wherein the metal core of the porous structure includes a metal selected from the group consisting of Fe, Cs, W, Mo, Ta, and Cu.

6. The electron multiplier of claim 5, wherein the metal core of the porous structure includes Fe.

7. The electron multiplier of claim 1, wherein the insulator material includes a compound selected from the group consisting of Al₂O₃, ZnO, CaO, SrO, SiO₂, MgO, La₂O₃, MgF₂, CaF₂, and LiF.

8. The electron multiplier of claim 7, wherein the insulator material includes Al₂O₃.

9. The electron multiplier of claim 1, wherein the layer of insulator material has a thickness of from about 500 Å to about 5000 Å.

10. A field emission display device comprising the electron multiplier of claim 1.

11. A flat light source comprising the electron multiplier of claim 1.

12. A liquid crystal display device comprising the flat light source of claim 1.

13. A photomultiplier comprising the electron multiplier of claim 1.

14. A method of manufacturing an electron multiplier comprising:
providing at least one porous structure having a plurality of pores, wherein the porous structure includes a metal core and a layer of insulator material coated on an outer surface of the metal core; and
assembling the porous structure between at least two electrodes, wherein one of the at least two electrodes has a plurality of electron emission tips formed on the electrode.

15. The method of claim 14, wherein the porous structure has a planar shape.

16. The method of claim 14, wherein the porous structure is a mesh.

17. The method of claim 14, wherein the size of the pores in the porous structure ranges from about 50 μm to about 2 mm.

18. The method of claim 14, wherein the metal core of the porous structure includes a metal selected from the group consisting of Fe, Cs, W, Mo, Ta, and Cu.

19. The method of claim 18, wherein the metal core of the porous structure includes Fe.

20. The method of claim 14, wherein the insulator material includes a compound selected from the group consisting of Al₂O₃, ZnO, CaO, SrO, SiO₂, MgO, La₂O₃, MgF₂, CaF₂, and LiF.

21. The method of claim 20, wherein the insulator material includes Al₂O₃.

22. The method of claim 21, wherein the providing at least one porous structure comprises:
depositing aluminum on the metal core of the porous structure; and
subjecting the aluminum-deposited metal core to a treatment under conditions effective to oxidize the aluminum and coat the metal core with a layer of aluminum oxide.

23. The method of claim 22, wherein the depositing aluminum is carried out by a process selected from the group consisting of thermal evaporation, sputtering, and e-beam evaporation.

24. The method of claim 22, wherein the subjecting the aluminum-deposited metal core to a treatment comprises:
immersing the aluminum-deposited metal core in an aqueous solution under conditions effective to convert the aluminum on the metal core to aluminum hydroxide; and
immersing the aluminum hydroxide-coated metal core in a solution under conditions effective to convert the aluminum hydroxide to aluminum oxide.

25. The method of claim 22, wherein the layer of aluminum oxide has a thickness of from about 500 Å to about 5000 Å.
